(19) United States
(12) Patent Application Publication
(10) Pub. No.: US 2025/0042133 A1
(43) Pub. Date: Feb. 6, 2025

(54) Temperature-adaptive radiative coating for all-season building thermal regulation

(71) Applicant: The Regents of the University of California, Oakland, CA (US)

(72) Inventors: Junqiao Wu, Kensington, CA (US); Kechao Tang, Beijing (CN); Kaichen Dong, Berkeley, CA (US); Jiachen Li, Berkeley, CA (US)

(21) Appl. No.: 18/718,298

(22) PCT Filed: Dec. 8, 2022
(86) PCT No.: PCT/US2022/081138

§ 371 Date: Jun. 10, 2024

Related U.S. Application Data
(60) Provisional application No. 63/289,823, filed on Dec. 15, 2021.

(51) Int. Cl. B32B 15/08; B32B 27/08

(52) U.S. Cl. CPC B32B 15/08; B32B 27/08; B32B 2250/02; B32B 2250/03; B32B 2250/04; B32B 2307/412; B32B 2307/7376

(57) ABSTRACT

This disclosure provides systems, methods, and apparatus related to a temperature-adaptive radiative coating for all-season thermal regulation. In one aspect, a device includes a substrate, a metal layer disposed on the substrate, a dielectric layer disposed on the metal layer, and a two-dimensional array of blocks of WₓV₁₋ₓO₂ embedded in the dielectric layer.

### RELATED APPLICATIONS

This application claims priority to U.S. Provisional Patent Application No. 63/289,823, filed Dec. 15, 2021, which is herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### BACKGROUND

In countries such as the United States, ˜39% of the total energy consumption is in buildings. For the residential housing energy portion, ˜51% is consumed for heating and cooling to maintain a desirable indoor temperature (˜22° C.). In contrast to most temperature regulation systems, which require external power input, the mid-infrared (IR) atmospheric transparency window (“sky window”) allows thermal radiation exchange between terrestrial surfaces and the 3 K outer space, thus opening a passive avenue for thermal radiative cooling of buildings. This method to cool an outdoor surface such as a roof has been extensively studied in the past. It is now advanced by the development of daytime radiative cooling using materials with low solar absorptance and high thermal emittance in the form of thin films, organic paints, or structural materials.

Past research on daytime radiative cooling, while successful in reducing cooling energy consumption, typically used materials with fixed, cooling-optimized properties, which efficiently emit thermal radiation even when the temperature of the surface is lower than desired, such as during the night or in the winter. This unwanted thermal radiative cooling will increase the energy consumption for heating and may offset the cooling energy saved in hot hours or seasons. This issue is well acknowledged by the research community, and mitigation of the overcooling has become a timely demand. To cut the heating penalty from overcooling, a few techniques were recently attempted for switching off thermal radiative cooling at low temperatures (below 22° C.). Although effective in switching, these techniques typically require either additional energy input or external activation, and in some cases, switching is achieved by mechanical moving parts.

Developing dynamic structures that automatically cease radiative cooling at low temperatures is therefore desirable. Existing efforts in self-switching radiative cooling, however, are either purely theoretical or limited to materials characterization with little relevance to practical household thermal regulation. Recently, a smart subambient coating was developed, focusing on the reduction of solar absorption by fluorescence rather than modulation of thermal emittance by temperature.

### SUMMARY

One innovative aspect of the subject matter described in this disclosure can be implemented in a device including a substrate, a metal layer disposed on the substrate, a dielectric layer disposed on the metal layer, and a two-dimensional array of blocks of WₓV₁₋ₓO₂ embedded in the dielectric layer.

Another innovative aspect of the subject matter described in this disclosure can be implemented in a device including a metal layer, a polymer layer disposed on the metal layer, the polymer layer defining a two-dimensional array of cavities, and WₓV₁₋ₓO₂ disposed in each cavity of the two-dimensional array of cavities.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows the basic property of a TARC in sky-window (8 μm to 13 μm) emittance modulation and schematics for temperature management when used as a household roof coating. The data points are the measured sky-window emittances of a TARC. The two bands represent the temperature-independent thermal emittance of metals and radiative coolers. FIG. 1B shows a TARC compared with other thermal regulation systems, highlighting the unique benefit of a TARC of being simultaneously energy-free and temperature adaptive.

FIG. 2A shows a schematic illustration of a TARC. FIGS. 2B and 2C show cross-sectional schematic illustrations of a TARC in an insulting state and a metallic state, respectively. FIG. 2D shows TIR images of a TARC compared with those of two conventional materials (references) with constantly low or high thermal emittance showing the temperature-adaptive switching in thermal emittance of TARC. FIG. 2E shows solar spectral absorptance and part of the thermal spectral emittance of TARC at a low temperature and a high temperature, measured by a UV-visible-NIR spectrometer with an integrating sphere and an FTIR spectrometer, respectively. Measurements (solid curves) show consistency with theoretical predictions (dashed curves).

FIG. 3 shows calibrated experimental cooling flux (power/area) of a TARC as a function of temperature in vacuum (the data line). Fitting of P″cool(T)Pcool″T at I and M states by the Stefan-Boltzmann radiation law gives ε_{w} values of 0.20 and 0.90, respectively.

FIG. 4A shows the surface temperature of a TARC, a commercial dark roof coating (A=0.70, ε_{w}=0.90), and a commercial white roof coating (A=0.15, F=0.90) in an open-space outdoor environment recorded over a day-night cycle. The measurement was taken in July in Berkeley, California (37.91° N, 122.28° W). The solid and dashed curves are experimental data and simulation results based on a local weather database, respectively. Measurements starting from 14:00 LDT were performed with the direct solar radiation blocked. Temperature observed after sunset show clear signs of the TARC shutting off thermal radiative cooling as its surface ambient temperature falls below T_{MIT}. FIG. 4B shows the measured ambient cooling power of TARC and white roof coating with direct solar radiation blocked in the outdoor environment.

FIG. 5A shows an example of a top-down schematic illustration of a TARC. FIG. 5B shows an example of a cross-sectional schematic illustration of a TARC.

FIG. 6 shows an example of a flow diagram illustrating a manufacturing process for a TARC.

FIGS. 7A-7C show examples of cross-sectional schematic illustrations of various stages in a method of fabricating a TARC.

FIG. 8A shows an example of a top-down schematic illustration of a TARC. FIG. 8B shows an example of a cross-sectional schematic illustration of a TARC.

FIG. 9 shows an example of a flow diagram illustrating a manufacturing process for a TARC.

FIGS. 10A-10D show examples of cross-sectional schematic illustrations of various stages in a method of fabricating a TARC.

FIG. 11A shows an example of a cross-sectional schematic illustration of a TARC. FIGS. 11B-11C show examples of top-down schematic illustrations of a TARC.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise

The terms “about” or “approximate” and the like are synonymous and are used to indicate that the value modified by the term has an understood range associated with it, where the range can be ±20%, +15%, +10%, +5%, or +1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

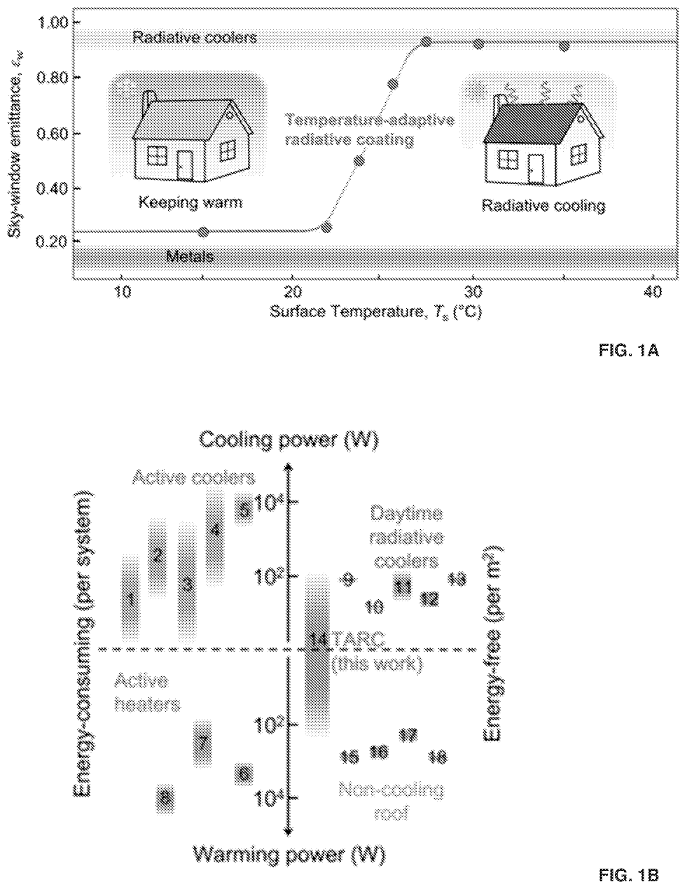

Described herein in the design and fabrication of a mechanically flexible coating structure to minimize total energy consumption through the entire year. This temperature-adaptive radiative coating (TARC) automatically switches its sky-window emittance to 0.90 from 0.20 when the surface temperature rises above ˜22° C., a practical threshold not previously available. The TARC delivers high radiative cooling power exclusively for the high-temperature condition (FIG. 1A). The TARC can also be optimized the solar absorptance at ˜0.25 (solar reflectance=0.75) for all-season energy saving in major US cities. The TARC demonstrates effective surface temperature modulation in an outdoor test environment. Simulations based on the device properties and the climate database were performed, which show advantages of TARC over existing roof coating materials in energy savings for most US cities in different climate zones. The energy savings by TARC not only bring economic benefits but also contribute to environmental preservation by reducing greenhouse gas emissions.

The TARC was developed based on the metal-insulator transition (MIT) of the strongly correlated electron materials WₓV₁₋ₓO₂, and the transition temperature (T_{M}IT) is tailored to ˜22° C. by setting the composition x at 1.5%.

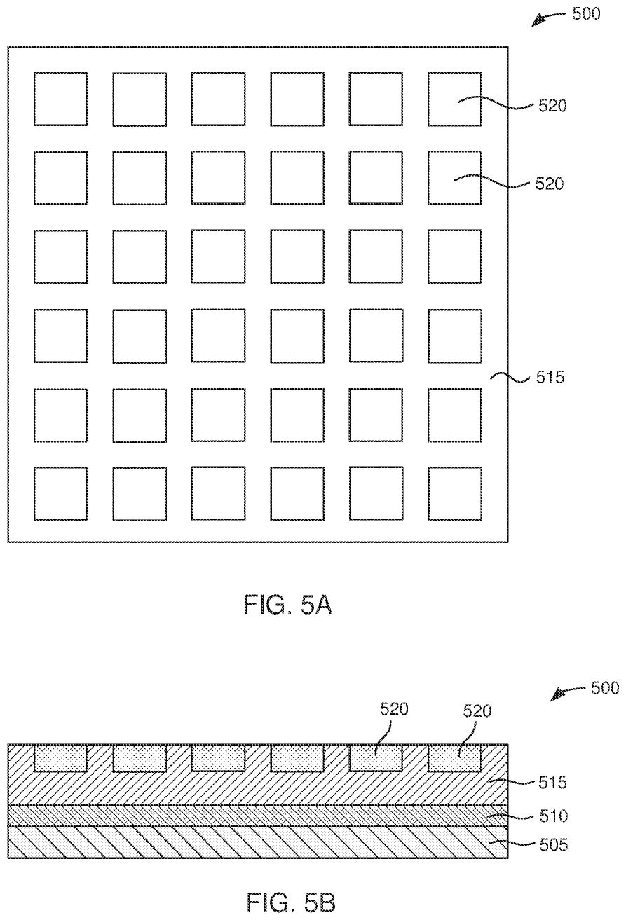

FIG. 5A shows an example of a top-down schematic illustration of a TARC. FIG. 5B shows an example of a cross-sectional schematic illustration of a TARC. As shown in FIGS. 5A and 5B, a TARC 500 includes a substrate 505, a metal layer 510 disposed on the substrate 505, a dielectric layer 515 disposed on the metal layer 510, and a two-dimensional array of blocks of WₓV₁₋ₓO₂ 520 embedded in the dielectric layer 515. In some embodiments, each of the blocks of WₓV₁₋ₓO₂ has a square or rectangular cross-section on a surface of the dielectric layer 515.

In some embodiments, the substrate 505 comprises a polymer. For example, in some embodiments, the substrate 505 comprises cellophane. In some embodiments, the substrate 505 comprises a dielectric material. In some embodiments, the substrate 505 comprises a metal.

In some embodiments, the metal layer 510 comprises a metal from the group titanium, niobium, tantalum, chromium, molybdenum, tungsten, manganese, iron, ruthenium, cobalt, rhodium, nickel, palladium, platinum, copper, silver, gold, zinc, aluminum, and alloys thereof. In some embodiments, the metal layer 510 is about 50 nanometers (nm) to 1 millimeter (mm) thick, or about 100 nm thick.

In some embodiments, when the substrate 505 comprises a metal, the metal layer 510 is not included in the TARC 500. That is, the substrate 505 serves as the metal layer 510 and no further substrate material is included in the TARC 500.

In some embodiments, the dielectric layer 515 is a dielectric from the group BaF₂, MgF₂, CaF₂, LiF, ZnSe, ZnS, NaCl, KBr, Si, Ge, GaAs CsI, KCl, CdTe, and the foregoing dielectrics including dopant(s). In some embodiments, the dielectric layer 515 is about 0.4 micron to 10 microns thick, or about 1.5 microns thick.

In some embodiments, blocks of the two-dimensional array of blocks of WₓV₁₋ₓO₂ 520 are about 20 nm to 1 micron thick. In some embodiments, blocks of the two-dimensional array of blocks of WₓV₁₋ₓO₂ 520 are about 70 nm thick. In some embodiments, a distance between a bottom surface of each of the blocks of WₓV₁₋ₓO₂ and the metal layer is about 0.4 micron to 2.5 microns. In some embodiments, each of the blocks of WₓV₁₋ₓO₂ 520 has a square or rectangular cross-section on a surface of the dielectric layer 515. In some embodiments, each of the blocks of WₓV₁₋ₓO₂ has dimensions of about 0.5 microns to 10 microns by about 0.5 microns to 10 microns on a surface of the dielectric layer.

In some embodiments, the dielectric layer 515 and the two-dimensional array of blocks of WₓV₁₋ₓO₂ 520 embedded in the dielectric layer form a substantially flat surface. In some embodiments, a polymer layer (not shown) is disposed on the dielectric layer 515 and the two-dimensional array of blocks of WₓV₁₋ₓO₂ 520 embedded in the dielectric layer. In some embodiments, the polymer layer comprises a polymer from the group polyethylene, polymethylpentene, polytetrafluoroethylene, polycarbonate, and the foregoing polymers including dopant(s).

In some embodiments, x in WₓV₁₋ₓO₂ is 0 to about 0.05, or about 0.015. In some embodiments, when the TARC is in in operation, when a temperature is less than the metal-insulator transition (MIT) temperature of the WₓV₁₋ₓO₂, the WₓV₁₋ₓO₂ is substantially transparent to infrared radiation. When a temperature is greater than the MIT temperature of the WₓV₁₋ₓ O₂, the WₓV₁₋ₓO₂ is substantially absorptive of infrared radiation. In some embodiments, the MIT is about −73° C. to 67° C., or about 22° C.

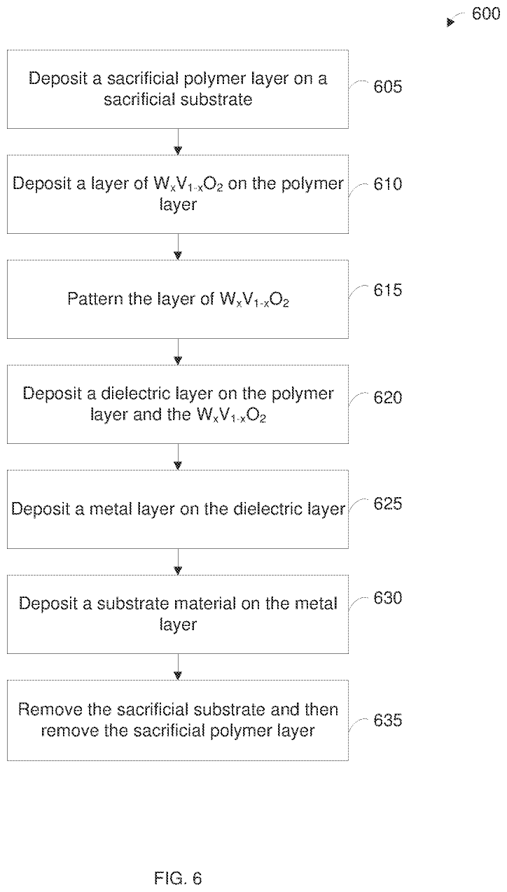

FIG. 6 shows an example of a flow diagram illustrating a manufacturing process for a TARC. The process 600 shown in FIG. 6 can be used to manufacture the TARC 500 shown in FIGS. 5A and 5B. Starting at block 605 of the process 600, a sacrificial polymer layer is deposited on a sacrificial substrate. In some embodiments, the sacrificial substrate comprises a silicon wafer. In some embodiments, the sacrificial polymer layer comprises polyimide. In some embodiments, the sacrificial polymer layer acts as an etching protection layer in the final operations of the process 600.

At block 610, a layer of WₓV₁₋ₓO₂ is deposited on the polymer layer. In some embodiments, the layer of WₓV₁₋ₓO₂ is about 20 nm to 1 micron thick, or about 70 nm thick. In some embodiments, the layer of WₓV₁₋ₓO₂ is deposited using sputtering, pulsed laser deposition (PLD), or atomic layer deposition (ALD).

At block 615, the layer of WₓV₁₋ₓO₂ is patterned. Patterning techniques, including masking as well as etching processes, are used to define the shapes of the WₓV₁₋ₓ O₂ blocks of the TARC. In some embodiments, the etching process is ion milling, reactive ion etching, or a chemical process.

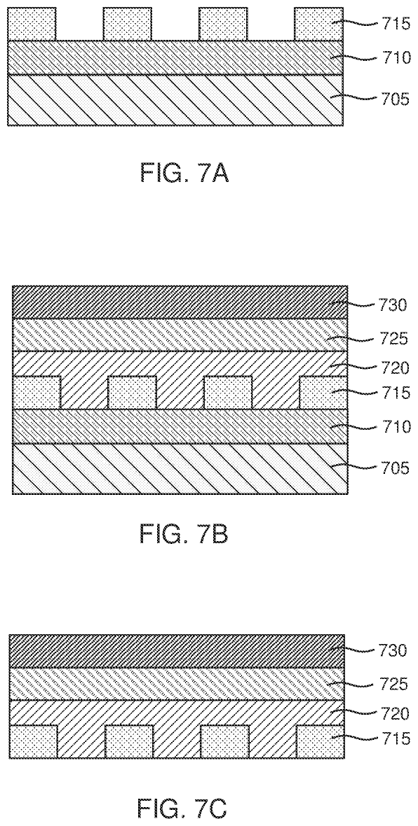

FIG. 7A shows an example of a schematic illustration of the partially fabricated TARC at this point (e.g., up through block 615) in the process 600. As shown in FIG. 7A, the partially fabricated TARC comprises a sacrificial substrate 705, a sacrificial polymer layer 710 disposed on the sacrificial substrate 705, and blocks of WₓV₁₋ₓO₂ 715 formed by the patterning techniques disposed on the sacrificial polymer layer 710.

Turning back to FIG. 6, at block 620 of the process 600, a dielectric layer is deposited on the polymer layer and the blocks of WₓV₁₋ₓO₂. In some embodiments, the dielectric layer is deposited using thermal evaporation, sputtering, plasma-enhanced chemical vapor deposition (PECVD), or atomic layer deposition (ALD). At block 625, a metal layer is deposited on the dielectric layer. In some embodiments, the metal layer is deposited using thermal evaporation or sputtering. At block 630, a substrate material is deposited on the metal layer. In some embodiments, the substrate material is deposited using spin-coating or chemical deposition.

FIG. 7B shows an example of a schematic illustration of the partially fabricated TARC at this point (e.g., up through block 630) in the process 600. As shown in FIG. 7B, the partially fabricated TARC comprises the sacrificial substrate 705, the sacrificial polymer layer 710 disposed on the sacrificial substrate 705, blocks of WₓV₁₋ₓO₂ 715 formed by the patterning techniques disposed on the sacrificial polymer layer 710, a dielectric layer 720 disposed on the sacrificial polymer layer 710 and the blocks of WₓV₁₋ₓO₂ 715, a metal layer 725 disposed on the dielectric layer 720, and a substrate material 730 disposed on the metal layer 725.

Turning back to FIG. 6, at block 635 of the process 600, the sacrificial substrate is removed and then the sacrificial polymer layer is removed. In some embodiments, the sacrificial substrate is removed via etching. For example, when the sacrificial substrate comprises a silicon wafer, the silicon substrate can be removed by etching or ion milling. In some embodiments, the sacrificial polymer layer can be removed using an oxygen plasma, a chemical solvent bath, or ion milling.

FIG. 7C shows an example of a schematic illustration of the fabricated TARC. The TARC comprises blocks of WₓV₁₋ₓO₂ 715 formed by the patterning techniques embedded in the dielectric layer 720, the metal layer 725 disposed on the dielectric layer 720, and the substrate material 730 disposed on the metal layer 725.

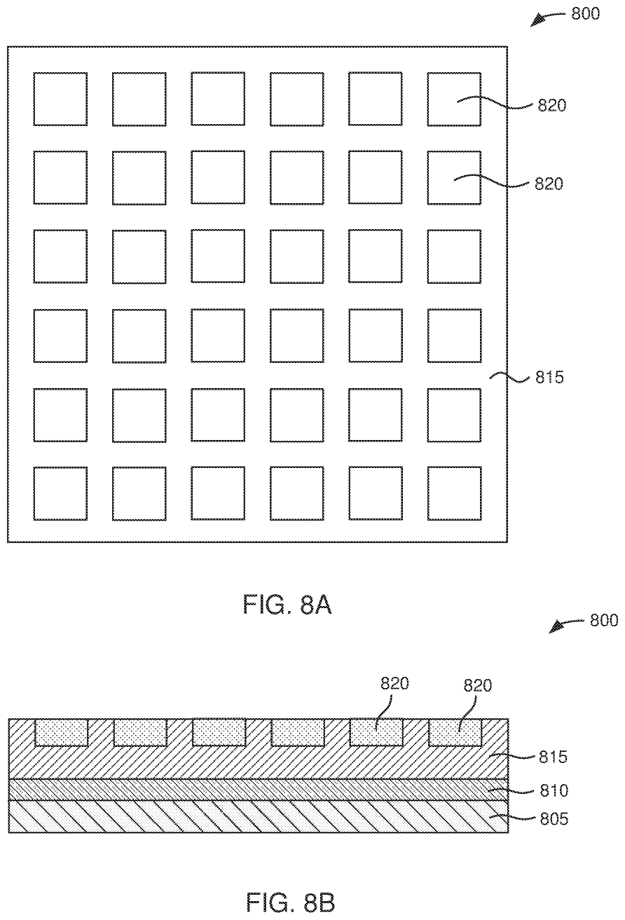

FIG. 8A shows an example of a top-down schematic illustration of a TARC. FIG. 8B shows an example of a cross-sectional schematic illustration of a TARC. As shown in FIGS. 8A and 8B, a TARC includes a metal layer 810 and a polymer layer 815 disposed on the metal layer 810. The polymer layer 815 defines a two-dimensional array of cavities or indentations. Nanoparticles of WₓV₁₋ₓO₂ 820 are disposed in each cavity of the two-dimensional array of cavities.

In some embodiments, the metal layer 810 comprises a metal from the group titanium, niobium, tantalum, chromium, molybdenum, tungsten, manganese, iron, ruthenium, cobalt, rhodium, nickel, palladium, platinum, copper, silver, gold, zinc, aluminum, and alloys thereof. In some embodiments, the metal layer 810 is about 50 nm to 1 mm thick, or about 100 nm thick.

In some embodiments, the polymer layer 815 comprises a polymer from the group polyethylene, polymethylpentene, polytetrafluoroethylene, polycarbonate, and the foregoing polymers including dopant(s). In some embodiments, each of the cavities or indentations defined in the polymer layer 815 a square or rectangular cross-section. In some embodiments, each cavity or indentation in the polymer layer 815 has dimensions of about 0.5 microns to 10 microns by about 0.5 microns to 10 microns. In some embodiments, each cavity or indentation defined in the polymer layer is about 20 nm to 1 micron deep, or about 70 nm deep.

In some embodiments, the nanoparticles of WₓV₁₋ₓO₂ disposed in each cavity or indentation in the polymer layer form a block having dimensions of about 0.5 microns to 10 microns by about 0.5 microns to 10 microns, by about 20 nm to 1 micron deep, or 70 nm. In some embodiments, a distance between a bottom surface of each of the blocks of nanoparticles of WₓV₁₋ₓO₂ and the metal layer is about 0.4 micron to 2.5 microns. In some embodiments, the polymer layer 815 and the WₓV₁₋ₓO₂ 820 form a substantially flat surface. In some embodiments, each of the nanoparticles of WₓV₁₋ₓO₂ has dimensions of about 10 nm to 1 micron. In some embodiments, a glue or binder in not use to keep nanoparticles in a cavity in the polymer layer.

In some embodiments, x in WₓV₁₋ₓO₂ is 0 to about 0.05, or about 0.015.

In some embodiments, when in operation, when a temperature is less than the metal-insulator transition (MIT) temperature of the WₓV₁₋ₓO₂, the WₓV₁₋ₓ O₂ is substantially transparent to infrared radiation. When a temperature is greater than the MIT temperature of the WₓV₁₋ₓ O₂, the WₓV₁₋ₓO₂ is substantially absorptive of infrared radiation. In some embodiments, the MIT is about −73° C. to 67° C., or about 22° C.

In some embodiments, the TARC 800 further comprises a substrate 805, with the metal layer 810 being disposed on the substrate 805. In some embodiments, the substrate 805 comprises a polymer. For example, in some embodiments, the substrate 805 comprises cellophane. In some embodiments, the substrate 805 comprises a dielectric material. In some embodiments, the substrate 805 comprises a metal.

In some embodiments, the TARC 800 further comprises a second polymer layer (not shown) disposed on the polymer layer 815 and the nanoparticles of WₓV₁₋ₓO₂ 820. In some embodiments, the second polymer layer comprises a polymer from the group polyethylene, polymethylpentene, polytetrafluoroethylene, polycarbonate, and the foregoing polymers including dopant(s).

In some embodiments, a second TARC 800 (without a metal layer 810) is placed on a TARC. In some embodiments, a third TARC 800 (without a metal layer 810) is placed on the second TARC.

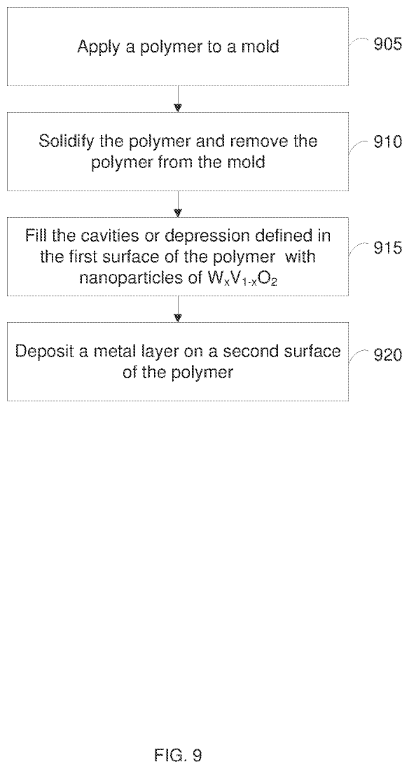

FIG. 9 shows an example of a flow diagram illustrating a manufacturing process for a TARC. The process 900 shown in FIG. 9 can be used to manufacture the TARC 800 shown in FIGS. 8A and 8B. Starting at block 905 of the process 900, a polymer is applied to a mold. The mold includes features that will form indentations or cavities in a first surface of the polymer. In some embodiments, the mold is fabricated from a silicon wafer.

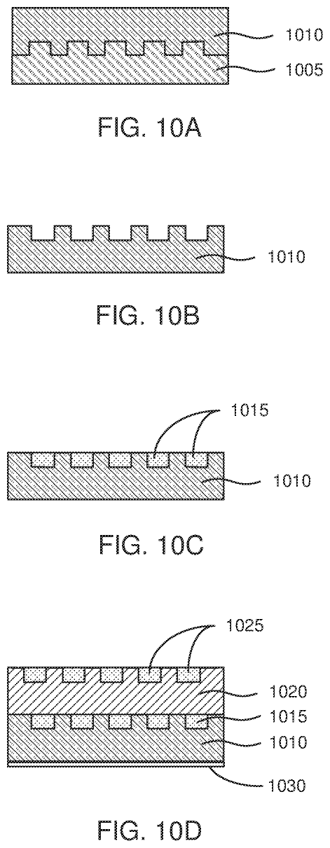

FIG. 10A shows an example of a cross-sectional schematic illustration of the partially fabricated TARC at this point (e.g., up through block 905) in the process 900. As shown in FIG. 10A, a polymer layer 1010 is disposed on a mold 1005.

Turning back to FIG. 9, at block 910 of the process 900, the polymer is solidified and removed from the mold. In some embodiments, the polymer is cured. In some embodiments, the polymer is cooled.

FIG. 10B shows an example of a cross-sectional schematic illustration of the partially fabricated TARC at this point (e.g., up through block 910) in the process 900. As shown in FIG. 10B, the partially fabricated TARC comprises the polymer layer 1010 with features defined in a first surface of the polymer layer.

Turning back to FIG. 9, at block 915 of the process 900, the cavities or depression defined in the first surface of the polymer are filed with nanoparticles of WₓV₁₋ₓO₂.

FIG. 10C shows an example of a cross-sectional schematic illustration of the partially fabricated TARC at this point (e.g., up through block 915) in the process 900. As shown in FIG. 10C, the partially fabricated TARC comprises the polymer layer 1010 with features defined in a first surface of the polymer layer filed with nanoparticles of WₓV₁₋ₓO₂ 1015.

Turning back to FIG. 9, at block 920 of the process 900, a metal layer is deposited on a second surface of the polymer. In some embodiments, the metal layer is deposited using thermal evaporation or sputtering. The second surface of the polymer is substantially parallel to the first surface of the polymer.

Blocks 905-915 of the process 900 can be repeated to form additional layers of the polymer with features that are filled with nanoparticles of WₓV₁₋ₓO₂. The additional layers may be stacked on top of one another as shown in FIG. 10D. FIG. 10D shows an example of a cross-sectional schematic illustration of a TARC including two layers of nanoparticles of WₓV₁₋ₓO₂. As shown in FIG. 10D, the TARC comprises the polymer layer 1010 with features defined in a first surface of the polymer layer filed with nanoparticles of WₓV₁₋ₓO₂ 1015 and a metal 1030 disposed on a second surface of the polymer layer 1010. Disposed on the first surface of the polymer layer 1010 is a second polymer layer 1020 with features defined in a first surface of the second polymer layer filed with nanoparticles of WₓV₁₋ₓO₂ 1025. Similarly, a TARC including two or more layers of blocks of WₓV₁₋ₓO₂ could be fabricated using the materials and processes described with respect to FIGS. 5A, 5B, and 6.

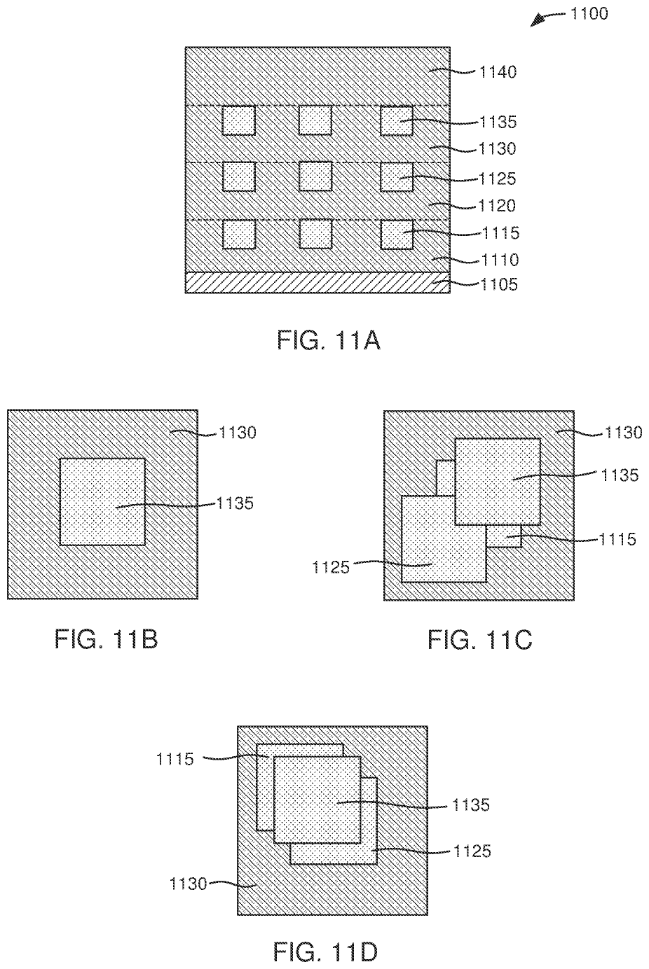

FIG. 11A shows an example of a cross-sectional schematic illustration of a TARC. FIGS. 11B-11D show examples of top-down schematic illustrations of a TARC. As shown FIG. 11A, a TARC 1100 comprises a metal layer 1105 and three polymer layers 1110, 1120, and 1130 with nanoparticles of WₓV₁₋ₓO₂ 1115, 1125, and 1135 disposed in features in a first surface of each of the polymer layers. In some embodiments, a polymer layer 1140 is disposed on the first surface of the third polymer layer 130.

As shown in FIGS. 11B-11D the features in the first surface of each of the polymer layers that are filled with nanoparticles of WₓV₁₋ₓO₂ can be aligned (FIG. 11B, all of the features in the polymer layers being on top of one another) or misaligned (FIGS. 11C and 11D, the features in the polymer layers being offset from one another). The features in the first surface of each of the polymer layers that are filled with nanoparticles of WₓV₁₋ₓO₂ being aligned or mis-aligned does not affect the performance of the TARC.

### Example

The following examples are intended to be examples of the embodiments disclosed herein, and are not intended to be limiting.

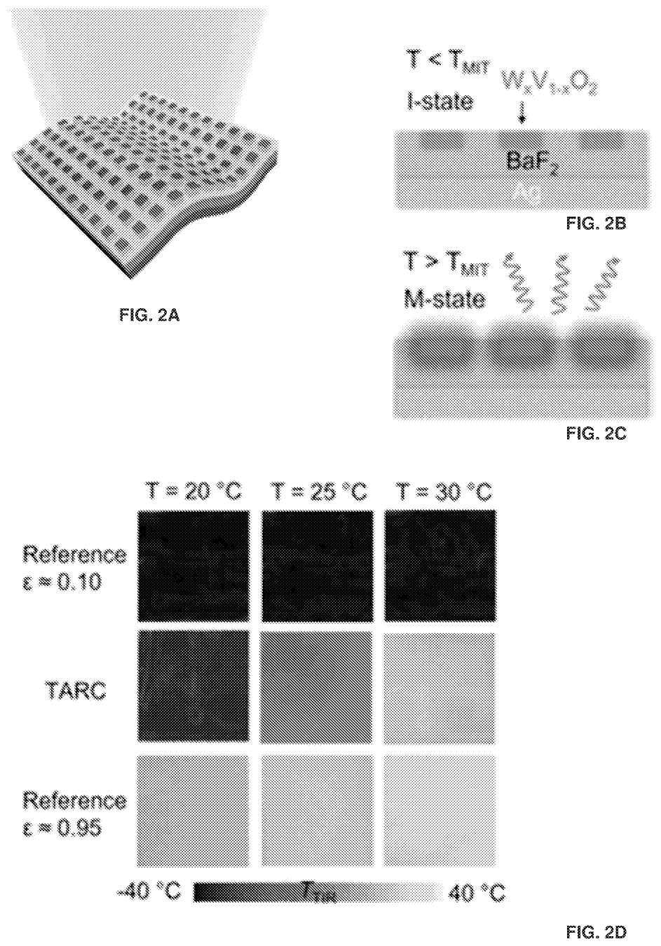

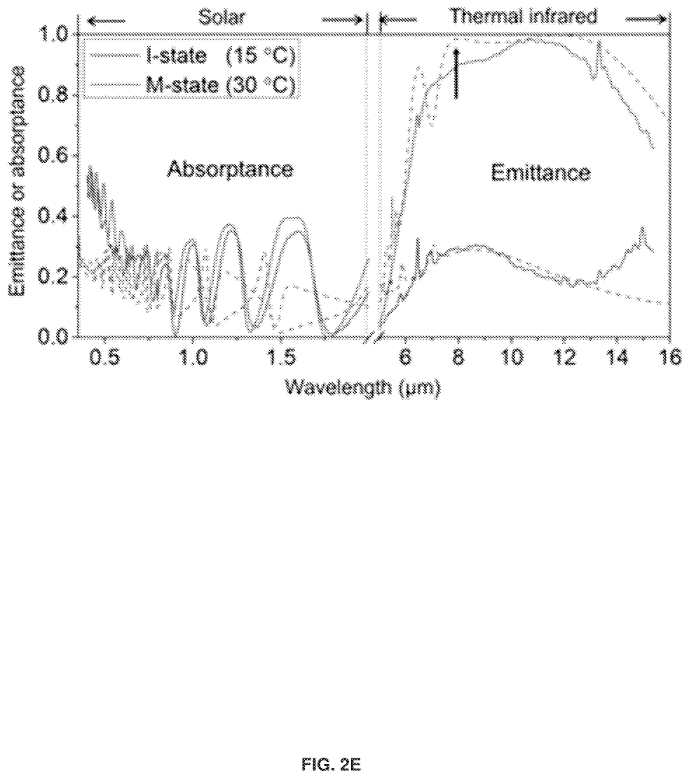

A lithographically patterned two-dimensional array of thin WₓV₁₋ₓO₂ blocks was embedded in a BaF₂ dielectric layer that sits on top of an Ag film (FIGS. 2A-2C). In the insulating (I) state of WₓV₁₋ₓO₂ at T<T_{MIT}, the material is largely transparent to the infrared (IR) radiation in the 8- to 13-μm sky spectral window, so this sky-window IR radiation is reflected by the Ag mirror with little absorption. By contrast, the WₓV₁₋ₓO₂ becomes highly absorptive in the sky window when it switches to the metallic (M) state at T>T_{MIT}. The absorption is further amplified by the designed photonic resonance with adjacent WₓV₁₋ₓO₂ blocks as well as with the bottom Ag layer through the ¼-wavelength cavity. The ¼-wavelength cavity structure induces Fabry-Perot resonance and was used in previous work to enhance thermal emission. According to Kirchhoff's law of radiation, the sky-window emittance equals the sky-window absorptance and switches from low to high when the temperature exceeds T_{MIT}. Consequently, strong sky-window radiative cooling is turned on in operation exclusively at high temperatures, leaving the system in the solar-heating or keep-warm mode at low temperatures.

To fabricate a TARC, 675 μm-thick Si wafers were first covered with an approximately 2 μm thick polyimide film via spin coating, which was then cured in a N₂-filled oven at 425° C. for 60 minutes. The polyimide film acts as an etching protection layer for the final transfer process. WₓV₁₋ₓO₂ thin films were grown on the polyimide layer using pulse laser deposition (PLD). The PLD target was prepared by mixing WO₃ and V₂O₅ powders with a W:V atomic ratio at 1.5%, then made into 2.5 cm diameter round discs with a hydraulic press. All WₓV₁₋ₓO₂ thin films were deposited in a 5 mTorr O2 environment at 500° C. substrate temperature, and the PLD laser energy was set at 321 mJ with 10 Hz pulse frequency. 70 nm of WₓV₁₋ₓO₂ was grown at a rate of 6 nm/min, followed by a post-deposition anneal at 500° C. for 30 mins in the same 5 mTorr O₂ environment. The metamaterials patterns were made with standard photolithography, combined with etching of WₓV₁₋ₓO₂ by SF₆+O₂ in a plasma etching system. After removing the photoresist with acetone and O₂ plasma, 1.5 μm thick BaF₂ and 100 nm thick Ag layers were grown sequentially on top via thermal evaporation. The growth rates of BaF₂ and Ag were controlled at 20 Å/s and 2 Å/s, respectively.

In the transfer process, a piece of 0.06 mm thick single-sided sticky cellophane packaging tape was first carefully applied to fully cover the surface, where the Ag layer was stuck to the adhesive side without any residual air bubbles. An initial Si substrate removal process was performed in a HF+HNO₃ solution, mixed by aqueous HF (49% weight percentage) and HNO₃ solution (68% weight percentage) with a volume ratio of 10:1. The samples were taken out and rinsed with DI water to stop the initial etching when the etchant starts to touch down on the polyimide layer. A XeF₂ dry etching process was then carried out to clean off the residue Si. In the final step, the polyimide protection layer was removed by O₂ plasma at 100 mTorr O₂ pressure and 200 W plasma power for about 11 mins.

The fabricated TARC has high flexibility for versatile surface adaption, as well as a microscale structure consistent with the design. The emittance switching was examined over the entire sample using a thermal infrared (TIR) camera (FIG. 2D). The TARC surface was imaged together with two reference samples having similar thicknesses but constant low thermal emittance (0.10, copper plate) or constant high thermal emittance (0.95, black tape), respectively. Although the thermal emission of the reference samples appeared to not be strongly temperature sensitive from 20 to 30° C., the TARC showed a change, corresponding to the switch in sky-window emittance at the MIT around 22° C.

The spectral properties of the TARC were measured by a UV-visible-NIR spectrometer and Fourier transform infrared spectroscopy (FTIR) for the solar and TIR wavelength regimes, respectively (FIG. 2E). The solar absorptance (A, 0.3 to 2.5 μm) was ˜0.25, and the sky-window emittance (s, 8 to 13 μm) was ˜0.20 in the I state and ˜0.90 in the M state, consistent with theoretical simulations and other characterization results.

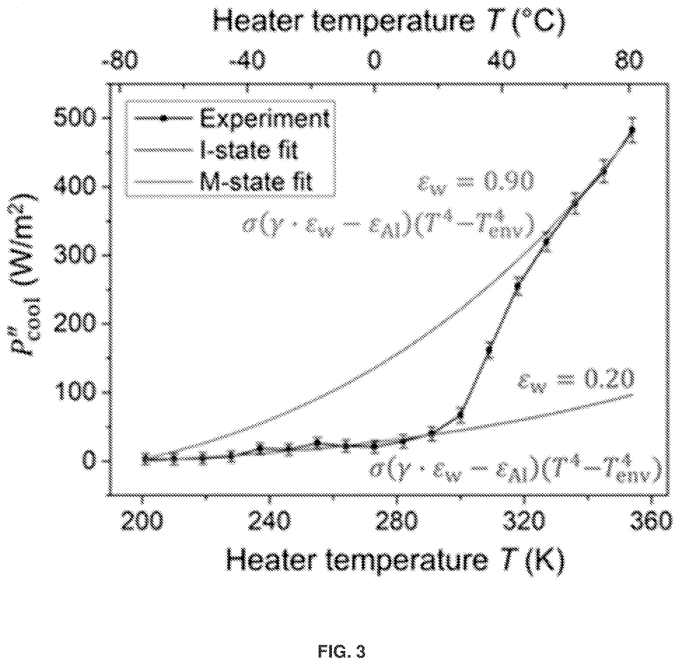

The emittance switching of the TARC enables deep modulation of radiative cooling power in response to ambient temperature, which was measured in vacuum. A heater membrane was suspended by thin strings in a vacuum chamber, which was cooled with dry ice to ˜−78° C. to minimize radiation from the chamber walls. A piece of Al foil with ε_{Al}≈0.03 or a TARC of the same size was attached to the top of the heater in two separate measurements. At each stabilized sample temperature T, the heating powers needed for the two coating scenarios are denoted as P_{Al}(T) and P_{TARC}(T), respectively. The cooling flux (power per areaA) contributed by the TARC was calculated as P″cool(T)=[P_{TARC}(T)−P_{Al}(T)]/A. The Al foil reference was used to calibrate background heat loss from thermal conduction through the strings. The calibrated cooling power (FIG. 3) was plotted, which shows an abrupt increase in P″cool(T) when T rises above the MIT temperature. P″cool(T) measurements in the I state and M state are well fitted by the Stefan-Boltzmann radiation law, with values of sky˜window ε_{w} extracted to be ˜0.20 and ˜0.90, respectively, consistent with the spectrally characterized results (FIG. 2E). The effect of radiation from the chamber wall (˜−78° C.) was considered and corrected for the calibration. A constant factor of γ(≈0.7) was introduced to account for the difference between the vacuum and ambient measurement conditions.

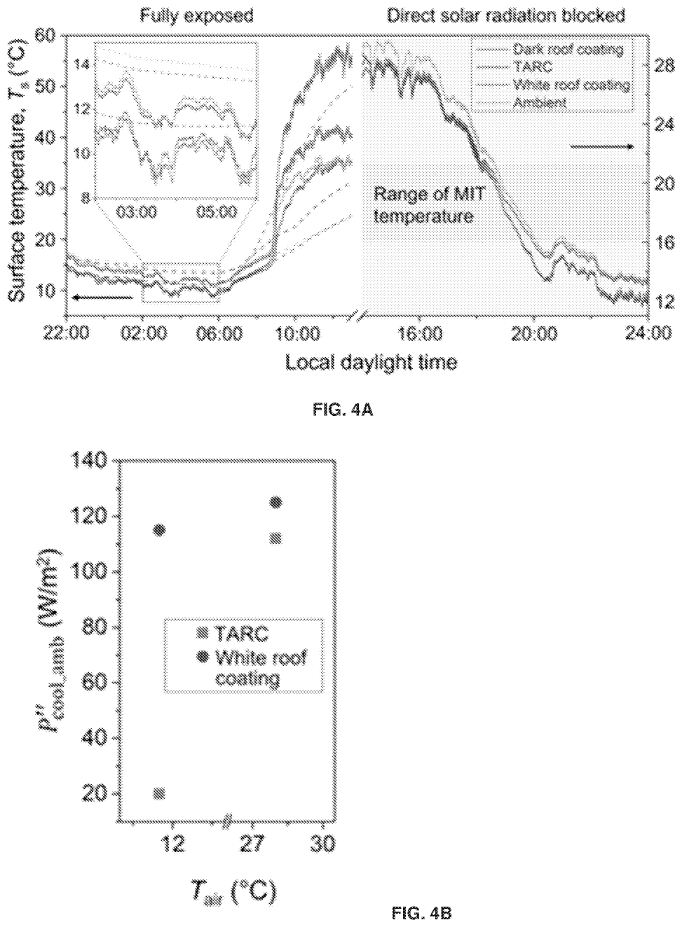

The actual outdoor performance of the TARC was demonstrated (FIGS. 4A and 4B). The surface temperatures (Tₛ) of the TARC was recorded, together with a dark roof coating product (asphalt gray) and a cool (white) roof coating product (white acrylic), over 24 hours on a sunny summer day on a rooftop in Berkeley, California, with a careful design of the measurement system to minimize the effects of artifacts.

From 00:00 to 09:00 local daylight time (LDT), when the ambient temperature was below T_{MIT}, the TARC was 2° C. warmer than the two reference roof coatings, arising from the low sky-window emittance (F=0.20) of the TARC in the I state and thus a lower radiative cooling power than the references (F=0.90). The 2° C. temperature elevation is consistent with adiabatic simulation results based on these nominal emittance values and the local weather database. From 09:00 to 13:00 LDT, when the samples were in direct sunlight, Tₛ was dominated by the solar absorption in balance with radiative cooling and air convection, and the differences between the samples agreed with the simulated results assuming the solar absorptance A to be 0.15, 0.25, and 0.70 for the white roof coating, TARC, and the dark roof coating, respectively. After 13:00 LDT, a shield was erected to intentionally block direct solar radiation to the surface of the samples. This imitates the scenario of a cloud blocking the sun but with the rest of the sky mostly clear. A convergence of the Tₛ curves for all three samples was observed, an indication that the thermal emittance of the TARC in the M state is close to that of the two references (0.90). This condition persisted for a few hours until Tₛ started to drop below T_{MIT}=22° C. After this point, TARC grew warmer than the two references, with a final temperature difference of ˜2° C., similar to the 00:00 to 09:00 LDT period. This indicates that the TARC switched to the low-emittance I state. The 24-hour outdoor experiments demonstrate the emittance switching and resultant temperature regulation by TARC. Although the white roof coating shows an advantage over TARC in thermal management in summer daytime and under solar radiation (FIG. 4A), the TARC regulates the roof temperature closer to the heating and cooling setpoints (22 and 24° C.) than the white roof coating for almost all of the other conditions, including daytime in other seasons and all of the nighttime. From an all-year-round perspective, the TARC demonstrates superiority compared with regular roof coatings in terms of source energy saving.

To directly compare their ambient condition cooling fluxes (P″cool_amb), the TARC and the white roof coating were heated to the air temperature with the direct solar radiation blocked. P″cool_amb refers to the net cooling flux from the surface-namely, the thermal radiative heat loss flux minus the absorbed diffuse solar irradiance. We plotted the P″cool_amb values that we obtained at a low and a high air temperature (FIG. 4B). The TARC exhibits a clear switching of P″cool_amb by a factor over five across the MIT. This behavior is in stark contrast to the nearly constant P″cool_amb around 120 W/m² for the shaded white roof coating, which is consistent with values (90 to 130 W/m²) reported in literature for roofs surfaced with daytime radiative cooling materials.

Numerical simulations were performed to analyze the performance of TARC in household energy saving for the US cities from an all-season perspective). The simulated results for Berkeley where the measurements (FIGS. 4A and 4B) were performed are presented here. An hour-month map of Tₛ was calculated using a local weather file, laying the basis for estimation of energy saving. Heating and cooling setpoints T_{set,heat}=22° C. and T_{set,cool}=24° C. were assumed, and the building was approximated to need heating when Tₛ<T_{set,heat} and require cooling when Tₛ>T_{set,cool}. Past simulations of cool-roof energy savings were used to predict potential space-conditioning source energy savings (SCSES) per unit roof area attainable by using TARC in place of roofing materials that have static values of solar absorptance and thermal emittance. The figure of merit of TARC is represented by SCSESₘᵢₙ, the minimum value of SCSES found over all existing conventional roofing materials, which have constant values of A_{ref} and ε_{ref}. SCSESₘᵢₙ for cities representing the 15 US climate zones was mapped. This figure-of-merit map shows that TARC provides clear, positive annual space-conditioning source energy savings relative to existing roof coating materials in most major cities, except for climates that are constantly cold (such as Fairbanks) or hot (such as Miami) throughout the year. It highlights the advantage of TARC, especially in climate zones with wide temperature variations, day to night or summer to winter. For example, it is estimated that for a single-family home in Baltimore, Maryland, built before 1980, modeled with roof assembly thermal insulance 4.3 m²/(K W), gas furnace annual fuel utilization efficiency 80%, and air conditioner coefficient of performance 2.64, SCSESₘᵢₙ is 22.4 MJ/(m²·y), saving 2.64 GJ/y based on a roof area of 118 m². The source energy saving of TARC was also calculated as a function of its solar absorptance, showing that the actual solar absorptance of TARC is close to the optimal value for major US cities.

The TARC could be readily upgraded for heavy-duty outdoor applications by coating it with a thin polyethylene (PE) membrane, which is nontoxic, hydrophobic, and transparent both in the visible and thermal IR regions. While protecting the TARC from contacting the dust and moisture in complex environments, the PE coating has little impact on the thermal modulation performance. The PE layer can be also replaced by other organic or inorganic materials with negligible optical loss in the wavelength ranges of both solar irradiation and IR atmospheric transparency window, so that the TARC technology can be designed specifically to be endurable in different environmental conditions.

### CONCLUSION

We developed a mechanically flexible, energy-free TARC for intelligent regulation of household temperature. Our system features a thermally driven metal-insulator transition in cooperation with photonic resonance, and demonstrates self-switching in sky-window thermal emittance from 0.20 to 0.90 at a desired temperature of −22° C. These attractive properties enable switching of the system from the radiative cooling mode at high temperatures to the solar-heating or keep-warm mode at low temperatures in an outdoor setting. For most cities in the United States, our simulations indicate the TARC may outperform all conventional roof materials in terms of cutting energy consumption for households.

Further details regarding the embodiments described herein can be found in K. Tang et al., “Temperature-adaptive radiative coating for all-season household thermal regulation,” Science, Volume 374, Issue 6574, 17 Dec. 2021, which is hereby incorporated by reference.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

This invention was made with support from the Bakar Fellows Program at the University of California, Berkeley.

1. A device comprising:
a substrate;
a metal layer disposed on the substrate;
a dielectric layer disposed on the metal layer; and
a two-dimensional array of blocks of WₓV₁₋ₓO₂ embedded in the dielectric layer.

2-5. (canceled)

6. The device of claim 1, wherein the metal layer comprises a metal from the group titanium, niobium, tantalum, chromium, molybdenum, tungsten, manganese, iron, ruthenium, cobalt, rhodium, nickel, palladium, platinum, copper, silver, gold, zinc, aluminum, and alloys thereof.

7. The device of claim 1, wherein the metal layer is about 50 nanometers to 1 millimeter thick.

8. The device of claim 1, wherein the dielectric layer is a dielectric from the group BaF₂, MgF₂, CaF₂, LiF, ZnSe, ZnS, NaCl, KBr, Si, Ge, GaAs CsI, KCl, CdTe, and the foregoing dielectrics including dopant(s).

9. The device of claim 1, wherein the dielectric layer is about 0.4 microns to 10 microns thick.

10. The device of claim 1, wherein blocks of the two-dimensional array of blocks of WₓV₁₋ₓO₂ are about 20 nanometers to 1 micron thick.

11. The device of claim 1, wherein x in WₓV₁₋ₓO₂ is 0 to about 0.05.

12. The device of claim 1, wherein a distance between a bottom surface of blocks of WₓV₁₋ₓO₂ and the metal layer is about 0.4 microns to 2.5 microns.

13. The device of claim 1, wherein each of the blocks of WₓV₁₋ₓO₂ has dimensions of about 0.5 microns to 10 microns by about 0.5 microns to 10 microns on a surface of the dielectric layer.

14. (canceled)

15. The device of claim 1, wherein when in operation, when a temperature is less than the metal-insulator transition (MIT) temperature of the WₓV₁₋ₓO₂ the WₓV₁₋ₓO₂ is substantially transparent to infrared radiation, and wherein when a temperature is greater than the MIT temperature of the WₓV₁₋ₓO₂ the WₓV₁₋ₓO₂ is substantially absorptive of infrared radiation.

16. (canceled)

17. The device of claim 1, further comprising:
a polymer layer disposed on the dielectric layer and the two-dimensional array of blocks of WₓV₁₋ₓO₂ embedded in the dielectric layer.

18. (canceled)

19. A device comprising:
a metal layer;
a polymer layer disposed on the metal layer, the polymer layer defining a two-dimensional array of cavities; and
WₓV₁₋ₓO₂ disposed in each cavity of the two-dimensional array of cavities.

20. The device of claim 19, further comprising:
a substrate, wherein the metal layer is disposed on the substrate.

21-24. (canceled)

25. The device of claim 19, wherein the metal layer comprises a metal from the group titanium, niobium, tantalum, chromium, molybdenum, tungsten, manganese, iron, ruthenium, cobalt, rhodium, nickel, palladium, platinum, copper, silver, gold, zinc, aluminum, and alloys thereof.

26. The device of claim 19, wherein the metal layer is about 50 nanometers to 1 millimeter thick.

27. The device of claim 19, wherein each cavity of the two-dimensional array of cavities is about 20 nanometers to 1 micron thick.

28. The device of claim 19, wherein x in WₓV₁₋ₓO₂ is 0 to about 0.05.

29. The device of claim 19, wherein each cavity of the two-dimensional array of cavities has dimensions of about 0.5 microns to 10 microns by about 0.5 microns to 10 microns on a surface of the polymer layer.

30. (canceled)

31. The device of claim 19, wherein when in operation, when a temperature is less than the metal-insulator transition (MIT) temperature of the WₓV₁₋ₓO₂ the WₓV₁₋ₓO₂ is substantially transparent to infrared radiation, and when a temperature is greater than the MIT temperature of the WₓV₁₋ₓO₂ the WₓV₁₋ₓO₂ is substantially absorptive of infrared radiation.

32. (canceled)

33. The device of claim 19, further comprising:
a second polymer layer disposed on the polymer layer and the WₓV₁₋ₓO₂.

34. (canceled)

35. (canceled)
